(19) United States
(12) Patent Application Publication
(10) Pub. No.: US 2016/0173754 A1
(43) Pub. Date: Jun. 16, 2016

(54) METHOD AND SYSTEM FOR ACTION SHOOTING AND SHOOTING CONTROL

(71) Applicant: Anhui Huami Information Technology Co., Ltd., Hefei (CN)

(72) Inventor: HUI WANG, Anhui (CN)

(21) Appl. No.: 14/960,513

(22) Filed: Dec. 7, 2015

(30) Foreign Application Priority Data
Dec. 15, 2014 (CN) 201410777581.X

(51) Int. Cl. H04N 5/232; H04N 7/18; B64C 39/02

(52) U.S. Cl. CPC H04N 5/23203; B64C 39/024; H04N 7/185; B64C 2201/146; B64C 2201/127

(57) ABSTRACT

Methods and apparatuses for action shooting and shooting control. The method for action shooting includes receiving a wireless broadcast signal transmitted by a wearable device upon takeoff of an aircraft; determining whether the wireless broadcast signal is from the wearable device paired with the aircraft; if the wireless broadcast signal is from the wearable device paired with the aircraft, controlling a shooting apparatus coupled to the aircraft for shooting according to the wireless broadcast signal.

### CROSS-REFERENCE TO RELATED APPLICATION

This application claims priority to Chinese patent application no. CN 201410777581.X, filed Dec. 15, 2014, which is incorporated herein in its entirety by reference.

### TECHNICAL FIELD

The present disclosure generally relates to wireless communication technologies, and more particularly, to methods and systems for action shooting and shooting control.

### BACKGROUND

As technology develops, it becomes normal for people to stay on mobile Internet and to interact with each other. People want to have their moments of life recorded and shared, such as in photographs and videos of sports in action. Action cameras have been widely used in extreme sport communities of surfing, skiing, biking, parachuting, and so forth.

In some instances, an action camera can be worn on a body part of a user, which may cause certain risks to sport. For instance, in a skiing scenario, when a fall accident occurs, the action camera worn on head may have a certain possibility to cause secondary injury to a human body, which raises potential safety hazard concern. On the other hand, if worn on the body of a moving user, the action camera cannot shoot the actions of the moving user.

### SUMMARY

Disclosed herein are implementations of methods and apparatuses for action shooting and shooting control. In one aspect, the present disclosure includes a method for shooting action from an aircraft comprising receiving a wireless broadcast signal transmitted by a wearable device paired with the aircraft in response to a takeoff indication of the aircraft, determining whether the wireless broadcast signal is from the wearable device paired with the aircraft, and controlling a shooting apparatus coupled to the aircraft for shooting in accordance with the wireless broadcast signal if the wireless broadcast signal is from the wearable device paired with the aircraft.

In another aspect, the present disclosure includes a method for shooting control for a wearable device comprising generating a wireless broadcast signal and broadcasting the wireless broadcast signal, wherein an aircraft paired with the wearable device controls a shooting apparatus coupled to the aircraft for shooting in accordance with the received wireless broadcast signal.

In another aspect, the present disclosure includes an apparatus for action shooting, comprising a reception module, wherein upon detecting a takeoff indication of an aircraft coupled to the apparatus, the reception module receives a wireless broadcast signal transmitted by a wearable device paired with the aircraft; a determination module, wherein the determination module determines whether the wireless broadcast signal is from the wearable device paired with the aircraft; and a control module, wherein based upon a determination that the wireless broadcast signal is from the wearable device paired with the aircraft, the control module controls the shooting apparatus for shooting in accordance with the wireless broadcast signal.

In another aspect, the present disclosure includes an apparatus for shooting control for a wearable device, comprising a generation module, wherein the generation module generates a wireless broadcast signal; and a broadcast module, wherein the broadcast module broadcasts the wireless broadcast signal, wherein an aircraft paired with the wearable device controls a shooting apparatus coupled to the aircraft for shooting in accordance with the received wireless broadcast signal.

The embodiments or implementations can be configured as executable computer program instructions stored in computer storages such as memory.

Features and advantages of the present disclosure will be set forth in the following descriptions and claims, accompanying drawings, or will be apparent from or by practice of the disclosure.

### BRIEF DESCRIPTION OF THE DRAWINGS

The description here makes reference to the accompanying drawings wherein like reference numerals refer to like parts throughout the several views, and where:

FIG. 1 is a flowchart of a method for action shooting according to implementations in this disclosure.

FIG. 2 is a flowchart of another method for action shooting according to implementations in this disclosure.

FIG. 3 is a schematic diagram of positions of a moving user and an aircraft according to implementations in this disclosure.

FIG. 4 is a flowchart of another method for action shooting according to implementations in this disclosure.

FIG. 5 is a flowchart of a method for shooting control according to implementations in this disclosure.

FIG. 6 is a flowchart of another method for shooting control according to implementations in this disclosure.

FIG. 7 is a block diagram of an apparatus for action shooting according to implementations in this disclosure.

FIG. 8 is a block diagram of a control module according to implementations in this disclosure.

FIG. 9 is a block diagram of a determination module according to implementations in this disclosure.

FIG. 10 is a block diagram of an apparatus for shooting control according to implementations in this disclosure; and

FIG. 11 is a block diagram of another apparatus for shooting control according to implementations in this disclosure.

### DETAILED DESCRIPTION

Example implementations of the present disclosure will be described below with reference to the accompanying drawings. The same numbers across the drawings set forth in the following description represent the same or similar elements, unless differently expressed. The implementations set forth in the following description do not represent all implementations or embodiments consistent with the present disclosure; on the contrary, they are only examples of apparatuses and methods in accordance with some aspects of this disclosure as detailed in the claims.

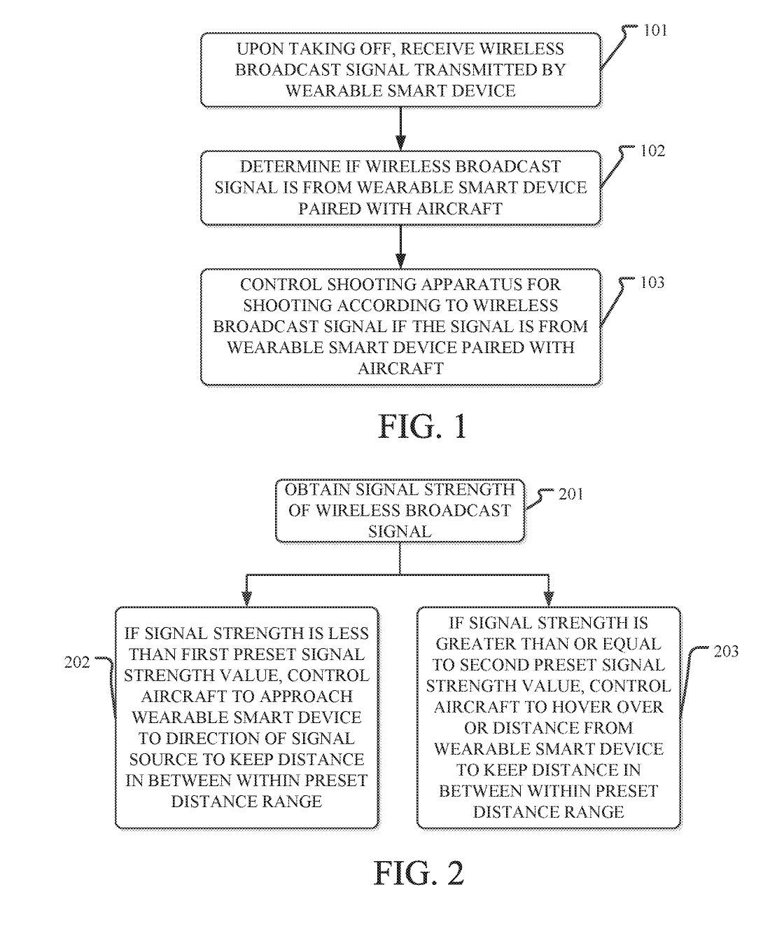

FIG. 1 is a flowchart of a method for action shooting according to one implementation in this disclosure. As illustrated in FIG. 1, this method can be used on an aircraft (e.g., an unmanned aerial vehicle) paired with a wearable device (e.g., a smart bracelet or wristband), wherein the aircraft carries a shooting apparatus. The shooting apparatus can be coupled to the aircraft, such as forming part of the aircraft, tied to, mounted on or carried by the aircraft, or otherwise associated with the aircraft. The method is set forth with details in the following descriptions.

In implementations of this disclosure, a shooting camera can be carried by an unmanned aerial vehicle (UAV), wherein the shooting camera can be matched to a lightweight wearable device worn on a body part of a user. For instance, the wearable device can be a smart bracelet or watch, wherein the UAV is paired to the smart bracelet worn by the user before taking off, by matching the UAV with a unique identifier of the smart bracelet. Therefore, when there is a plurality of users wearing smart bracelets, the UAV is able to follow the mere smart bracelet paired with it and to shoot the user.

At operation 101, upon taking off, such as in response to a take off indication of the aircraft, a wireless broadcast signal transmitted by the wearable device is received.

At operation 102, it is determined that whether the wireless broadcast signal is from the wearable device paired with the aircraft.

At operation 103, based on a determination that the wireless broadcast signal is from the wearable device paired with the aircraft, the shooting apparatus can be controlled for shooting according to the wireless broadcast signal.

For example, action tracking for shooting can be implemented by paring the aircraft (such as one carrying the shooting apparatus) with the wearable device worn by the user. For example, in an accident, the user can avoid possible injuries caused by wearing the shooting apparatus on body, and the potential safety hazard caused by the shooting apparatus in high-speed motion is eliminated. In addition, the user experience can be improved if the action process of the moving user is captured.

Optionally, the abovementioned operation 103 includes the following operations.

If the wireless broadcast signal is from the wearable device paired with the aircraft, in accordance with signal strength and signal source direction of the wireless broadcast signal, a flight direction of the aircraft and a shooting angle of the shooting apparatus is controlled for shooting a user wearing the wearable device. Here, the flight direction of the aircraft can include horizontal and vertical flight directions of the aircraft, and the shooting angle of the shooting apparatus can include angles of the lens of the shooting apparatus respectively with respect to horizontal and vertical directions.

In the implementations, the flight direction of the aircraft and the shooting angle of the shooting apparatus can be determined, according to the signal strength and the signal source direction of the wireless broadcast signal received by the aircraft, or based on a distance between the aircraft and the user wearing the wearable device, wherein the aircraft keeps tracking the user within a certain distance range, and the shooting apparatus keeps shooting to the direction of the signal source of the wireless broadcast signal. Thus, accurate action tracking to the moving user by the aircraft can be implemented with improved shooting effect and user experience.

FIG. 2 is a flowchart of another method for action shooting according to implementations in this disclosure. As illustrated in FIG. 2, optionally, the aforementioned operation 103 includes the following operations.

At operation 201, the signal strength of the wireless broadcast signal is obtained.

At operation 202, if the signal strength is less than a first preset signal strength value, the aircraft is controlled to approach the wearable device along the signal source direction to make the distance between the aircraft and the wearable device being within a preset distance range.

At operation 203, if the signal strength is greater than or equal to a second preset signal strength value, the aircraft is controlled to hover over or distance from the wearable device to make the distance between the aircraft and the wearable device being within the preset distance range.

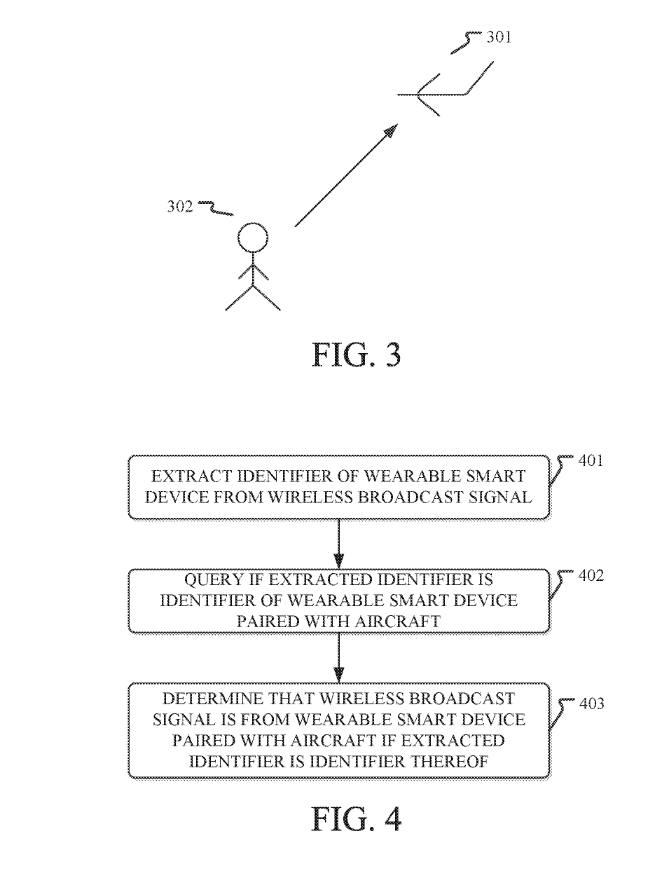

For instance, as illustrated in FIG. 3, the distance range between aircraft 301 and the wearable device (moving user 302) can be set to be 5-10 meters, and the aircraft can be always kept to the left behind the wearable device. If the signal strength of the wireless broadcast signal received by the aircraft is less than a preset minimum value, i.e. if the distance between the aircraft and the wearable device is greater than 10 meters, the aircraft is controlled to approach the wearable device; if the signal strength of the wireless broadcast signal received by the aircraft is greater than a preset maximum value, i.e. if the distance between the aircraft and the wearable device is less than 5 meters, the aircraft is controlled to hover over or distance from the wearable device.

In the implementations, in accordance with the signal strength of the received wireless broadcast signal, the aircraft can be always kept within a certain distance from and at a certain direction to the wearable device, wherein accurate action tracking to the moving user by the aircraft can be implemented with improved shooting effect and user experience.

FIG. 4 is a flowchart of another method for action shooting according to implementations in this disclosure. As illustrated in FIG. 4, optionally, the aforementioned operation 102 includes the following operations.

At operation 401, an identifier of the wearable device can be extracted from the wireless broadcast signal.

At operation 402, it can be queried whether the extracted identifier is identical to an identifier of the wearable device paired with the aircraft.

At operation 403, if the extracted identifier is identical to the identifier thereof, it can be decided that the wireless broadcast signal is from the wearable device paired with the aircraft.

In the implementations, the wireless broadcast signal transmitted by the wearable device includes the unique identifier of its own, according to which the aircraft can decide whether the wearable device had been paired with itself, therefore confirms the user for tracking shoot. Thus, the aircraft is able to accurately track the unique moving user for shooting, such that accurate shooting to the moving user can be implemented, with improved shooting effect and user experience.

Optionally, the abovementioned operation 103 includes the following operations.

If the wireless broadcast signal is from the wearable device paired with the aircraft, the shooting apparatus is controlled to execute a preset shooting operation according to the wireless broadcast signal.

In the implementations, the wearable device may control the aircraft for specific operations through the wireless broadcast signal, such as controlling a camera to shoot, switch off the camera, or change shooting directions by pre-configurations and so forth, wherein the control for shoot tracking of the aircraft by the moving user is implemented with more convenience and improved user experience.

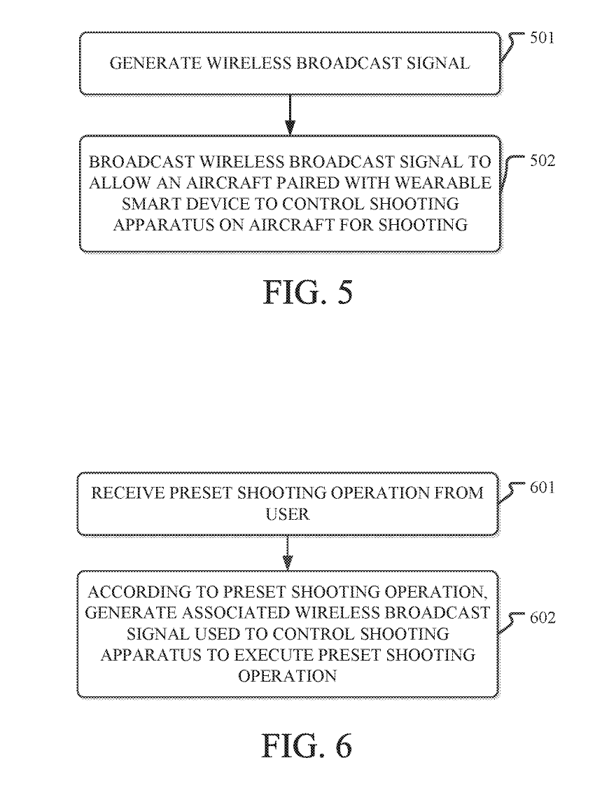

FIG. 5 is a flowchart of a method for shooting control according to implementations in this disclosure. As illustrated in FIG. 5, this method can be used in a wearable device, wherein the details are set forth in the following descriptions.

At operation 501, a wireless broadcast signal is generated.

At operation 502, the wireless broadcast signal is broadcasted, wherein an aircraft paired with the wearable device controls a shooting apparatus on the aircraft for shooting in accordance with the received wireless broadcast signal.

In this implementation, the wearable device generates and broadcasts the broadcast signal for controlling the aircraft and the shooting apparatus. By coordinating the aircraft carrying the shooting apparatus and the wearable device worn by a moving user, action tracking for shooting is implemented, wherein in an accident, the user avoids possible injuries caused by wearing the shooting apparatus on body, and the potential safety hazard caused by the shooting apparatus in high-speed motion is eliminated. In addition, the user experience is improved if the action process of the moving user is captured.

Optionally, the wireless broadcast signal can include an identifier of the wearable device.

In the implementations, the wearable device adds its own unique identifier to the wireless broadcast signal. Thereby, when there is a plurality of users wearing smart bracelets, the aircraft is always able to follow the mere wearable device paired with it and to shoot the user thereof.

FIG. 6 is a flowchart of another method for shooting control according to implementations in this disclosure. As illustrated in FIG. 6, optionally, the method can include the following operations.

At operation 601, a preset shooting operation of the wearable device is received from the user.

The aforementioned operation 501 can include operation 602, whereat the wireless broadcast signal is generated in accordance with the preset shooting operation, wherein the wireless broadcast signal associated with the preset shooting operation is used to control the shooting apparatus to execute the preset shooting operation.

In the implementations, the preset shooting operation can be preset for the wearable device to control the aircraft or the camera to execute specific operations, such as upon a tapping gesture to the wearable device, the camera can be controlled to shoot, switch off, or change its shooting directions according to pre-configurations, wherein the control for shoot tracking of the aircraft by the moving user is implemented with more convenience and improved user experience.

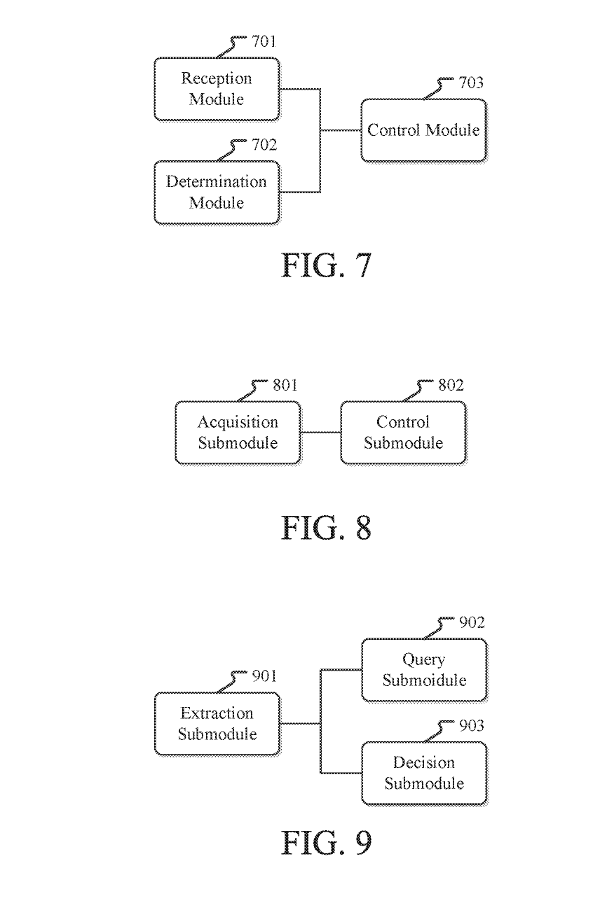

FIG. 7 is a block diagram of an apparatus for action shooting according to implementations in this disclosure. Corresponding to the method provided in the implementations of the present disclosure, an implementation of the present disclosure further provides an apparatus for action shooting, as shown in FIG. 7. The apparatus includes, for examples, the following modules 701 to 703, and optionally 801-802 and 901-902, all of which can be implemented by software, or hardware, or an implementation combining software and hardware aspects.

As illustrated in FIG. 7, the apparatus can be implemented or used on an aircraft carrying a shooting apparatus paired with a wearable device, wherein details of the apparatus are set forth in the following descriptions.

Reception module 701 receives a wireless broadcast signal transmitted by the wearable device upon the aircraft taking off.

Determination module 702 determines whether the wireless broadcast signal is from the wearable device paired with the aircraft.

If the wireless broadcast signal is from the wearable device paired with the aircraft, control module 703 controls the shooting apparatus for shooting according to the wireless broadcast signal.

Optionally, if the wireless broadcast signal is from the wearable device paired with the aircraft, according to signal strength and signal source direction of the wireless broadcast signal, control module 703 controls a flight direction of the aircraft and a shooting angle of the shooting apparatus for shooting a user wearing the wearable device.

FIG. 8 is a block diagram of a control module according to implementations in this disclosure. As illustrated in FIG. 8, optionally, control module 703 includes the following submodules.

Acquisition submodule 801 acquires the signal strength and the signal source direction of the wireless broadcast signal.

If the signal strength is less than a preset signal strength value, control submodule 802 controls the aircraft to approach the wearable device to the direction of signal source, wherein the distance between the aircraft and the wearable device is within a preset distance range; if the signal strength is greater than or equal to a second preset signal strength value, control submodule 802 controls the aircraft to hover over or distance from the wearable device, wherein the distance between the aircraft and the wearable device is within the preset distance range.

FIG. 9 is a block diagram of a determination module according to implementations in this disclosure. As illustrated in FIG. 9, optionally, determination module 702 includes the following submodules.

Extraction submodule 901 extracts an identifier of the wearable device from the wireless broadcast signal.

Query submodule 902 queries whether the extracted identifier is identical to an identifier of the wearable device paired with the aircraft.

If the extracted identifier is identical to the identifier thereof, decision submodule 903 decides that the wireless broadcast signal is from the wearable device paired with the aircraft.

Optionally, if the wireless broadcast signal is from the wearable device paired with the aircraft, control module 703 controls the shooting apparatus to execute a preset shooting operation according to the wireless broadcast signal.

By coordinating the aircraft carrying the shooting apparatus and the wearable device worn by the moving user, the apparatus of this implementation implements action tracking for shooting, wherein in an accident, the user avoids possible injuries caused by wearing the shooting apparatus on body, and the potential safety hazard caused by the shooting apparatus in high-speed motion is eliminated. In addition, the user experience is improved if the action process of the moving user is captured.

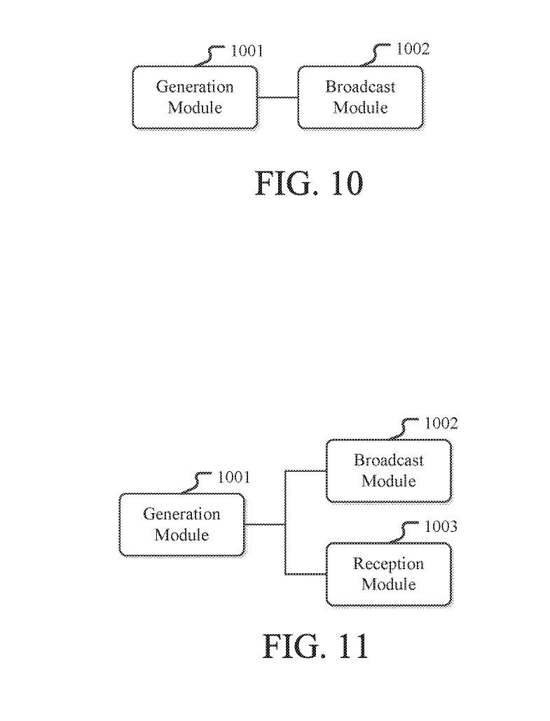

FIG. 10 is a block diagram of an apparatus for shooting control according to implementations in this disclosure. Corresponding to the method provided in the implementations of the present disclosure, an implementation of the present disclosure further provides an apparatus for shooting control, as shown in FIG. 10. The apparatus includes, for examples, the following modules 1001 to 1002, and optionally 1003, all of which can be implemented by software, or hardware, or an implementation combining software and hardware aspects.

As illustrated in FIG. 10, this device is used in a wearable device which includes the following modules.

Generation module 1001 generates a wireless broadcast signal.

Broadcast module 1002 broadcasts the wireless broadcast signal, wherein an aircraft paired with the wearable device controls a shooting apparatus on the aircraft for shooting in accordance with the received wireless broadcast signal.

FIG. 11 is a block diagram of a second device for shooting control according to implementations in this disclosure. As illustrated in FIG. 11, optionally, the apparatus includes the following modules.

Reception module 1003 receives a preset shooting operation for the wearable device from a user.

According to the preset shooting operation, generation module 1001 generates the wireless broadcast signal associated with the preset shooting operation, wherein the wireless broadcast signal associated with the preset shooting operation controls the shooting apparatus to execute the preset shooting operation.

In this implementation, the wearable device generates and broadcasts the broadcast signal for controlling the aircraft and the shooting apparatus. By coordinating the aircraft carrying the shooting apparatus and the wearable device worn by the moving user, action tracking for shooting is implemented, wherein in an accident, the user avoids possible injuries caused by wearing the shooting apparatus on body, and the potential safety hazard caused by the shooting apparatus in high-speed motion is eliminated. In addition, the user experience is improved if the action process of the moving user is captured.

For the apparatuses in aforementioned implementations, the specific operations executed by each module have been described with details in implementations of the methods; therefore no detailed instructions will be set forth for the operations thereof herein.

Technical specialists skilled in the art should understand that, the implementations in this disclosure can be implemented as methods, systems, or computer program products. Therefore, this disclosure can be implemented in forms of a complete hardware implementation, a complete software implementation, and a combination of software and hardware implementation. Further, this disclosure can be embodied as a form of one or more computer program products which are embodied as computer executable program codes in computer writable storage media (including but not limited to disk storage and optical storage).

This disclosure is described in accordance with the methods, devices (systems), and flowcharts and/or block diagrams of computer program products of the implementations, which should be comprehended as each flow and/or block of the flowcharts and/or block diagrams implemented by computer program instructions, and the combinations of flows and/or blocks in the flowcharts and/or block diagrams. The computer program instructions therein can be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flowcharts and/or one or more blocks in the block diagrams.

The computer program instructions can be also stored in a computer readable storage which is able to boot a computer or other programmable data processing device to a specific work mode, wherein the instructions stored in the computer readable storage produce a manufactured product containing the instruction devices which implements the functions designated by one or more flows in the flowcharts and/or one or more blocks in the block diagrams.

The computer program instructions may also be loaded to a computer or another programmable data processing device to execute a series of operating procedures in the computer or the other programmable data processing device to produce a process implemented by the computer, wherein the computer program instructions executed in the computer or the other programmable data processing device provide the operating procedures for the functions designated by one or more flows in the flowcharts and/or one or more blocks in the block diagrams.

Apparently, the technical specialists skilled in the art may perform any variation and/or modification to this disclosure by the principles and within the scope of this disclosure. Therefore, if the variations and modifications herein are within the scope of the claims and other equivalent techniques herein, this disclosure intends to include the variations and modifications thereof.

What is claimed is:

1. A method for shooting action from an aircraft, comprising:
in response to a takeoff indication of the aircraft, receiving a wireless broadcast signal transmitted by a wearable device paired with the aircraft;
determining whether the wireless broadcast signal is from the wearable device paired with the aircraft; and
based upon a determination that the wireless broadcast signal is from the wearable device paired with the aircraft, controlling a shooting apparatus coupled to the aircraft for shooting in accordance with the wireless broadcast signal.

2. The method of claim 1, wherein based upon a determination that the wireless broadcast signal is from the wearable device paired with the aircraft, the controlling the shooting apparatus for shooting in accordance with the wireless broadcast signal comprises:
based upon a determination that the wireless broadcast signal is from the wearable device paired with the aircraft, in accordance with a signal strength and a signal source direction of the wireless broadcast signal, controlling a flight direction of the aircraft and a shooting angle of the shooting apparatus for shooting a user wearing the wearable device.

3. The method of claim 2, wherein in accordance with a signal strength and a signal source direction of the wireless broadcast signal, the controlling a flight direction of the aircraft and a shooting angle of the shooting apparatus comprises:
obtaining the signal strength of the wireless broadcast signal;
based upon a determination that the signal strength is less than a first preset signal strength value, controlling the aircraft to approach the wearable device to the direction of signal source, wherein the distance between the aircraft and the wearable device is within a preset distance range; and
based upon a determination that the signal strength is greater than or equal to a second preset signal strength value, controlling the aircraft to hover over or distance from the wearable device, wherein the distance between the aircraft and the wearable device is within the preset distance range.

4. The method of claim 1, wherein the determining whether the wireless broadcast signal is from the wearable device paired with the aircraft comprises:
extracting an identifier of the wearable device from the wireless broadcast signal;
determining whether the extracted identifier is identical to an identifier of the wearable device paired with the aircraft; and
based upon a determination that the extracted identifier is identical to the identifier of the wearable device paired with the aircraft, determining that the wireless broadcast signal is from the wearable device paired with the aircraft.

5. The method of claim 1, wherein based upon a determination that the wireless broadcast signal is from the wearable device paired with the aircraft, the controlling the shooting apparatus for shooting in accordance with the wireless broadcast signal comprises:
based upon a determination that the wireless broadcast signal is from the wearable device paired with the aircraft, in accordance with the wireless broadcast signal, controlling the shooting apparatus to execute a preset shooting operation.

6. A method for shooting control for a wearable device, comprising:
generating a wireless broadcast signal; and
broadcasting the wireless broadcast signal, wherein an aircraft paired with the wearable device controls a shooting apparatus coupled to the aircraft for shooting in accordance with the received wireless broadcast signal.

7. The method of claim 6, wherein the wireless broadcast signal comprises an identifier of the wearable device.

8. The method of claim 7, further comprising:
receiving a preset shooting operation for the wearable device from a user; wherein the generating a wireless broadcast signal further comprises:
in accordance with the preset shooting operation, generating the wireless broadcast signal associated with the preset shooting operation, wherein the wireless broadcast signal associated with the preset shooting operation is used to control the shooting apparatus to execute the preset shooting operation.

9. An apparatus for action shooting, comprising:
a reception module, wherein upon detecting a takeoff indication of an aircraft coupled to the apparatus, the reception module receives a wireless broadcast signal transmitted by a wearable device paired with the aircraft;
a determination module, wherein the determination module determines whether the wireless broadcast signal is from the wearable device paired with the aircraft; and
a control module, wherein based upon a determination that the wireless broadcast signal is from the wearable device paired with the aircraft, the control module controls the shooting apparatus for shooting in accordance with the wireless broadcast signal.

10. The apparatus of claim 9, wherein based upon a determination that the wireless broadcast signal is from the wearable device paired with the aircraft, in accordance with signal strength and signal source direction of the wireless broadcast signal, the control module controls a flight direction of the aircraft and a shooting angle of the shooting apparatus for shooting a user wearing the wearable device.

11. The apparatus of claim 10, wherein the control module comprises:
an acquisition submodule, wherein the acquisition submodule acquires the signal strength and the signal source direction of the wireless broadcast signal; and
a control submodule, wherein based upon a determination that the signal strength is less than a first preset signal strength value, the control submodule controls the aircraft to approach the wearable device to the direction of the signal source, wherein the distance between the aircraft and the wearable device is within a preset distance range; based upon a determination that the signal strength is greater than or equal to a second preset signal strength value, the control submodule controls the aircraft to hover over or distance from the wearable device, wherein the distance between the aircraft and the wearable device is within the preset distance range.

12. The apparatus of claim 9, wherein the determination module comprises:
an extraction submodule, wherein the extraction submodule extracts an identifier of the wearable device from the wireless broadcast signal;
a query submodule, wherein the query submodule queries whether the extracted identifier is identical to an identifier of the wearable device paired with the aircraft; and
a decision submodule, wherein based upon a determination that the extracted identifier is identical to the identifier of the wearable device paired with the aircraft, the decision submodule decides that the wireless broadcast signal is from the wearable device paired with the aircraft.

13. The apparatus of claim 9, wherein based upon a determination that the wireless broadcast signal is from the wearable device paired with the aircraft, the control module controls the shooting apparatus to execute a preset shooting operation in accordance with the wireless broadcast signal.

14. An apparatus for shooting control for a wearable device, comprising:
a generation module, wherein the generation module generates a wireless broadcast signal; and
a broadcast module, wherein the broadcast module broadcasts the wireless broadcast signal, wherein an aircraft paired with the wearable device controls a shooting apparatus coupled to the aircraft for shooting in accordance with the received wireless broadcast signal.

15. The apparatus of claim 14, further comprising:
a reception module, wherein the reception module receives a preset shooting operation for the wearable device from a user; and
the generation module, wherein in accordance with the preset shooting operation, the generation module generates the wireless broadcast signal associated with the preset shooting operation, wherein the wireless broadcast signal associated with the preset shooting operation controls the shooting apparatus to execute the preset shooting operation.
